(19) United States
(12) Patent Application Publication
(10) Pub. No.: US 2010/0082245 A1
(43) Pub. Date: Apr. 1, 2010

(54) SYSTEM AND METHOD FOR INDIVIDUALLY UPDATING A LOCATION-BASED GEOMETRIC BOUNDARY OF A SUBSCRIBER VEHICLE

(75) Inventors: RUSSELL A. PATENAUDE, MACOMB TOWNSHIP, MI (US); CHRISTINE E. MEISSNER, ROYAL OAK, MI (US); GARY A. WATKINS, ROYAL OAK, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, DETROIT, MI (US)

(21) Appl. No.: 12/239,729

(22) Filed: Sep. 26, 2008

(51) Int. Cl. G01C 21/36; H04W 4/04

(52) U.S. Cl. 701/209; 455/456.1; 701/208

(57) ABSTRACT

A system and method for individually updating a location-based geometric boundary of a subscriber vehicle that is one of many subscriber vehicles are disclosed herein. The method includes obtaining a garage address of the subscriber vehicle, and determining a location-based geometric boundary of the subscriber vehicle from at least the garage address. The method further includes monitoring at least one of a service event including at least a vehicle registration event, a driving distance, or a driving speed to determine a driving pattern of the subscriber vehicle. The location-based geometric boundary of the subscriber vehicle is dynamically updated based at least on the driving pattern of the subscriber vehicle.

### TECHNICAL FIELD

The present disclosure relates generally to a system and a method for individually updating a location-based geometric boundary of a subscriber vehicle.

### BACKGROUND

It is known to configure telematics units with a geometric boundary. When the vehicle associated with the telematics unit travels outside the set geometric boundary, a registration is sent to a call center in order to apprise the call center of the vehicle's location. Such registrations are sent such that the two entities (i.e., the vehicle and the call center) are in sync as to the vehicle location. When such a report is received, the call center may reset the vehicle's geometric boundary utilizing an average boundary for all subscriber vehicles.

### SUMMARY

A system and method for individually updating a location-based geometric boundary of a subscriber vehicle that is one of many subscriber vehicles are disclosed herein. The method includes obtaining a garage address of the subscriber vehicle, and determining a location-based geometric boundary of the subscriber vehicle from at least the garage address. The method further includes monitoring at least one of a service event including at least a vehicle registration event, a driving distance, or a driving speed to determine a driving pattern of the subscriber vehicle. The location-based geometric boundary of the subscriber vehicle is dynamically updated based at least on the driving pattern of the subscriber vehicle.

### BRIEF DESCRIPTION OF THE DRAWINGS

Features and advantages the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a system for individually updating a location-based geometric boundary of a subscriber vehicle;

FIG. 2 is a flow diagram depicting an example of the method for individually updating a location-based geometric boundary of a subscriber vehicle;

FIG. 3 is a semi-schematic diagram of a location-based geometric boundary of a subscriber vehicle, and a targeted message that may be sent from a call center to such subscriber vehicle;

FIG. 4 is a flow diagram depicting an additional example of the method for individually updating a location-based geometric boundary of a subscriber vehicle; and

FIG. 5 is a flow diagram depicting still another example of the method for individually updating a location-based geometric boundary of a subscriber vehicle.

### DETAILED DESCRIPTION

Examples of the method and system disclosed herein advantageously enable a geometric boundary of an individual vehicle to be updated based, at least in part, on a driving pattern of the vehicle. As used herein, a “geometric boundary” is a shape that defines an area around the vehicle in which the vehicle may travel without transmitting a registration (indicative of a then-current vehicle position) to the call center.

The geometric boundary may be personalized for a particular vehicle, rather than updated based upon an average boundary for multiple vehicles. This may be particularly advantageous for subscriber vehicles living near coastal areas, at least in part because average geometric boundaries for such subscribers may encompass multiple miles of non-drivable areas. Furthermore, by individually updating each vehicle's geometric boundary, the number of vehicle registrations sent to a call center from such vehicles may be decreased. It is believed that this is due, at least in part, to the fact that the individualized geometric boundary takes into account the vehicle's driving pattern, and thus daily trips that are in accordance with the driving pattern will not trigger a registration event. Still further, if subscriber vehicles are equipped with such individualized geometric boundaries, messages sent to such vehicles from the call center may be tailored for each specific geometric boundary rather than being generic to accommodate the average geometric boundary.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. As such, indirect communication may include communication between two components with additional component(s) located therebetween.

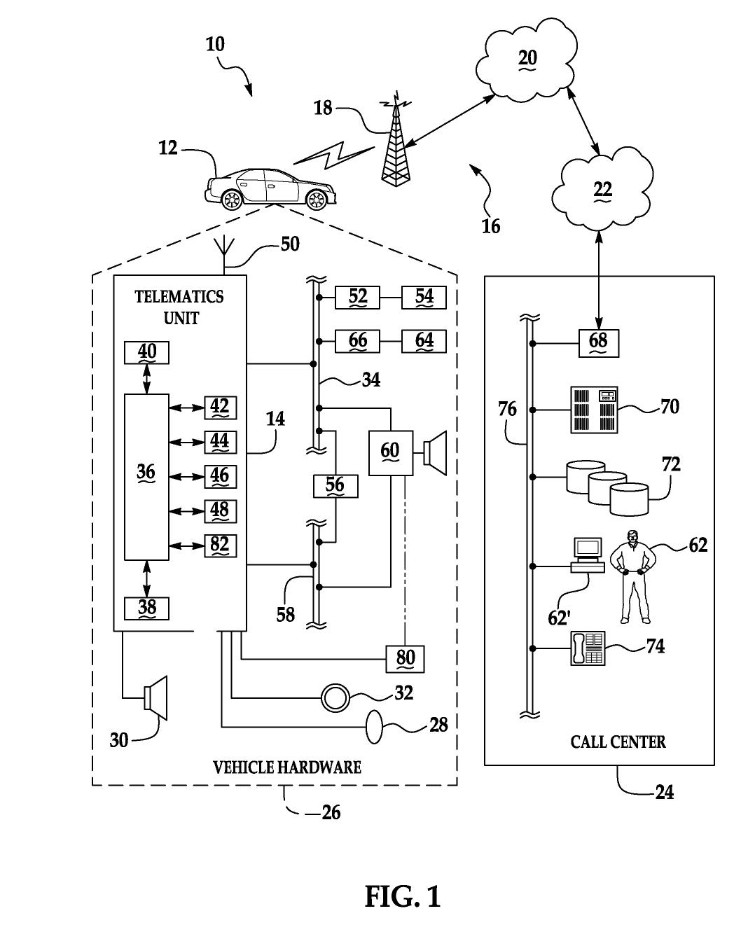

Referring now to FIG. 1, the system 10 includes a subscriber vehicle 12, a telematics unit 14, a wireless carrier/communication system 16 (including, but not limited to, one or more cellular networks which includes one or more towers 18 and one or more base stations and/or mobile switching centers (MSCs) 20 operated by one or more cellular service providers), one or more land networks 22, and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Subscriber vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14. The subscriber vehicle 12 is generally associated with a user's account with a telematics service provider, where the vehicle 12 receives telematics services from such provider.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24, which is associated with the telematics service provider (not shown). The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 80, which may be operatively connected to the telematics unit 14 directly, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system/network or any other suitable wireless system/network that transmits signals between the vehicle hardware 26 and land network 22. As previously mentioned, wireless carrier/communication system 16 includes one or more cell towers 18, 18′, 18″, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

A cellular service provider generally owns and/or operates the wireless carrier/communication system 16. It is to be understood that, although a cellular service provider (not shown) may be located at or work in conjunction with the call center 24, the call center 24 is a separate and distinct entity from the cellular service provider. In an example, the cellular service provider is located remote from the call center 24. A cellular service provider provides the user with telephone and/or Internet services, while the call center 24 is a telematics service provider. The cellular service provider is generally a wireless carrier (such as, for example, Verizon Wireless®, AT&T®, Sprint®, etc.). It is to be understood that the cellular service provider may interact with the call center 24 to provide one or more cellular and/or telematics service(s) to the user.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes one or more switches 68, servers 70, databases 72, live and/or automated advisors 62, 62′, as well as a variety of other telecommunication and computer equipment 74 that is known to those skilled in the art. These various call center components are coupled to one another via a network connection or bus 76, such as the one (vehicle bus 34) previously described in connection with the vehicle hardware 26.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

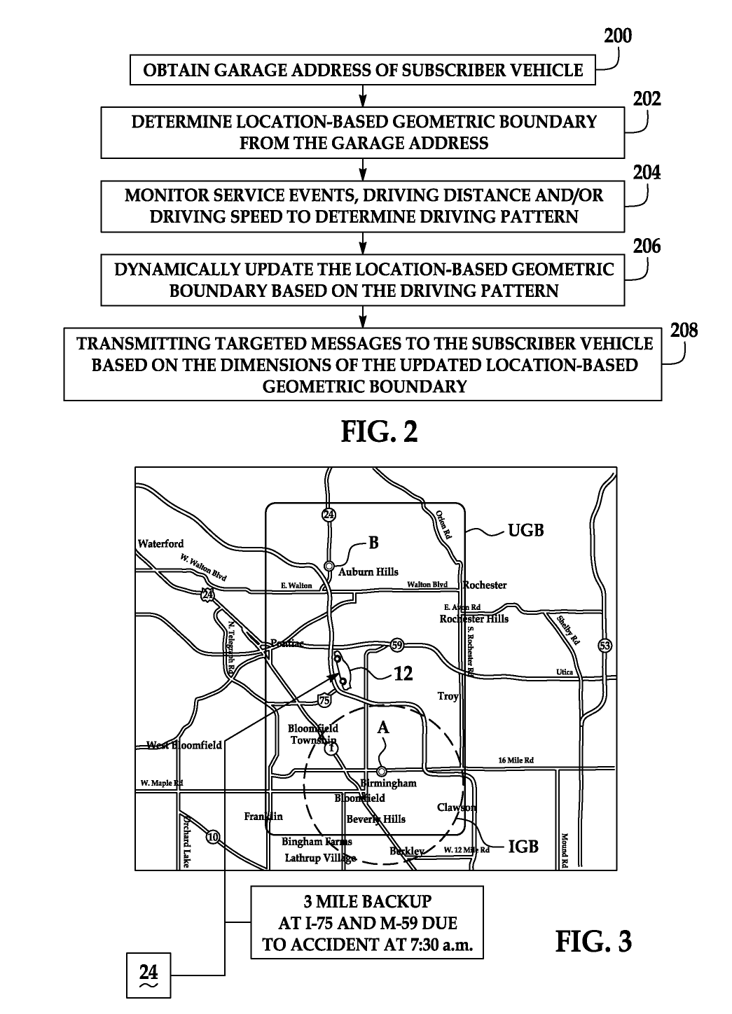

Referring now to FIG. 2, an example of the method for individually updating a location-based geometric boundary of the subscriber vehicle 12 is depicted. It is to be understood that either the telematics unit 14 or the call center 24, or the two working together, may be configured to perform the methods disclosed herein. As such, updating the geometric boundary may be entirely an on-board function, entirely a back-end function, or a combination of on-board and back-end functions. In any instance, the dynamic updates advantageously minimize the number of registrations transmitted from the vehicle 12 to the call center 24, and enable more specialized messages to be transmitted to the vehicle 12 from the call center 24. The various examples will be described further hereinbelow.

As shown in FIG. 2, the garage address of the subscriber vehicle 12 is determined (see reference numeral 200). The term “garage address”, as used herein, refers to the home or account address of the subscriber associated with the vehicle 12. In one example, such information may be supplied from the vehicle user to a call center advisor 62, 62′ when the user initially subscribes to telematics services. Such information may be stored in one or both of the telematics unit memory 38 and the user's profile (e.g., in database 72) at the call center 24. It is to be understood that the user's garage address may be updated at any time throughout the duration of the user maintaining an account with the telematics service provider. When the telematics unit 14 is performing the method shown in FIG. 2, the garage address is generally retrieved from the memory 38, and when the call center 24 is performing the method shown in FIG. 2, the garage address is generally retrieved from the user's profile in the database 72.

Using at least the garage address, either the telematics unit 14 or the call center advisor 62, 62′ determines an initial location-based geometric boundary for the vehicle 12, as shown at reference numeral 202. This location-based geometric boundary may be any suitable shape (circular, square, rectangular, elliptical, etc.), and may or may not have the subscriber vehicle garage address as its geometric center. The initial location-based geometric boundary may be based on the geographic region in which the garage address is located, historical weather patterns of the geographic region, types of weather incidents in the geographic region (e.g., floods, hurricanes, tornados, etc.), an account type associated with the subscriber vehicle 12 (e.g., personal account, fleet account, etc.), a population density of the geographic region, or combinations thereof.

The telematics unit 14 may retrieve such geographic related or user account related information from the memory 38 (if such information is stored therein) or an onboard navigation system (which may be configured to correlate position with geography type), or may transmit a data request for such information from the call center 24. The call center advisors 62, 62′ may retrieve such geographic related or user account related information from suitable information resources (e.g., news source (such as, for example, a national news radio or television station, and/or an Internet news source, such as CNN.com and REUTERS.com, etc.), a government source (such as, for example, a local government contact), a public or private company source (such as, for example, a contact at the American Red Cross®), and/or a weather source (such as, for example, The Weather Channel®, the National Oceanic & Atmospheric Administration (NOAA) weather service)), and/or from the user's profile.

Upon receiving and analyzing such information, the telematics unit 14 (via an algorithm programmed in the processor 36) or the call center advisor 62, 62′ (via an algorithm programmed in an operator station (not shown)) defines the initial location-based geometric boundary for the subscriber vehicle 12. As a non-limiting example, the initial location-based geometric boundary for a user having a fleet account may be larger than for a user having a personal account. As another non-limiting example, the initial location-based geometric boundary for a user living in a rural area (with a potential to consistently drive long distances) may be larger than a user living in an urban area. One or more of the above geographic and account factor may be considered when setting the initial location-based geometric boundary. A non-limiting example of an algorithm used to increase or decrease the initial geometric boundary (e.g., a radius or side lengths of a rectangle) uses weighted values. For instance, the home or garage address city population may be used to scale an original distance (usually a default boundary or an arbitrarily set boundary that does not take into consideration any other factors) by multiplying the original distance by a correlated value “x” based on the population (e.g., population=1 million, x=1, but population=500 thousand, x=1.5). This scaled boundary is set as the initial boundary.

In addition to or as an alternative to analyzing the above geographic and/or user account factors to determine the initial geometric boundary, the telematics unit 14 or the call center advisor 62, 62′ (via an algorithm programmed in an operator station) may also scale the initial location-based geometric boundary using an algorithm that optimizes the boundary. This algorithm is configured to balance an estimated number of location-based geometric boundary transmissions (e.g., registrations) to the call center 24 from the subscriber vehicle 12 with an estimated number of target messages to be transmitted from the call center 24 to the subscriber vehicle 12 based on the dimensions of the location-based geometric boundary. When the geometric boundary is too small, the vehicle 12 may transmit an undesirable number of registrations to the call center 24. For example, once the vehicle 12 has exceeded the set boundary, it transmits a registration every certain number of miles (e.g., 5, 10, etc.) it travels beyond the boundary. When the geometric boundary is too large, the number of registrations may be reduced; however, the number of messages may increase (and be less targeted) due to the degradation in location accuracy. For example, a vehicle 12 may receive messages pertaining to areas within the boundary but well outside its daily travel routine. The algorithm enables the initial geometric boundary to be scaled to achieve a desirable balance between potentially transmitted registrations and potentially transmitted targeted messages. In some instances, the dimensions of the initial geometric boundary are set so that the estimated number of registrations is equal to or within a predetermined range of the estimated number of messages.

It is to be understood that the geographic and/or account factors outlined above may be useful in tweaking the balance between registrations and targeted messages transmitted in order to define the initial geometric boundary. For example, if the garage address of the vehicle 12 is Miami, Fla., the urban area may weigh in favor of shrinking the boundary (potentially resulting in an increased number of vehicle registration transmissions and a decreased number of more accurately targeted messages), but the fact that the area is a hurricane region may weigh in favor of increasing the boundary (potentially resulting in a decreased number of vehicle registrations and an increased number of less accurately targeted messages, for example, to include all hurricane warnings). Still further, the fact that Miami is on the coast may also assist in setting the initial boundary so that little or none of the boundary includes the water.

After the initial location-based geometric boundary is determined, such boundary is set both in the telematics unit 14 and in the user's profile at the call center 24. If the telematics unit 14 determines the initial boundary, it sends the boundary to the call center 24 as a data transmission for storage in the user's profile. If the call center 24 determines the initial boundary, it sends the boundary to the telematics unit 14 as a data transmission for storage in its memory 38. With such a transmission, regardless of which entity determines the initial boundary, the telematics unit 14 and the call center 24 are in sync.

It is to be understood that the initial boundary is used to determine when, if ever, the subscriber vehicle 12 transmits a registration to the call center 24, and to determine when, if ever, the call center 24 transmits a targeted message to the subscriber vehicle 12, until such initial boundary is updated. After the initial boundary is set, the telematics unit 14 or the call center 24 monitors at least service events, driving distances, and/or driving speed to determine a driving pattern for the subscriber vehicle 12, as shown at reference numeral 204. When a particular driving pattern is recognized, the telematics unit 14 or the call center 24 may dynamically update the location-based geometric boundary based on the driving pattern, as shown at reference numeral 206.

When the telematics unit 14 performs the monitoring, service events may include registrations sent to the call center 24, ignition cycles, cellular activity, location detection chipset/component 44 activity, and other like in-vehicle activities that may assist in identifying driving patterns. Suitable sensors 64 may be used to monitor such events, driving distances and/or driving speeds, and the real-time clock 46 may date and/or time stamp such information, which is logged into the memory 38. Other data, such as wireless use and geographic position may also be logged into the memory 38. The data is then analyzed via an algorithm programmed in the processor 36 to determine a driving pattern of the vehicle. It is to be understood that monitoring may be accomplished for any amount of time that is sufficient to recognize a pattern.

As previously mentioned, if/when the telematics unit 14 recognizes the pattern, it updates the geometric boundary stored in its memory 38 based on the pattern. The telematics unit 14 includes an enabler 82 (shown in FIG. 1) in its hardware that is configured to update the geometric boundary. In one example, the enabler 82 would be software that is configured to monitor such data, and using preset thresholds to alter the shape of the boundary. As a non-limiting example, the enabler 82 may recognize that for ten consecutive days, the vehicle 12 has driven inside its initial boundary. The enabler 82 may then determine (from the saved position data) the maximum distance incurred during the ten days and adjust the boundary using this maximum distance. Such updated geometric boundary is also sent to the call center 24 so that the telematics unit 14 and call center 24 have identical information for the subscriber vehicle 12.

In a non-limiting example, the telematics unit 14 may recognize that for five days in one week a user drives short distances from his/her garage address to various destinations in various directions. The telematics unit 14 may look at the ignition cycles, the fact that registrations are never being sent (because the driver is within the initial geometric boundary), the GPS component 44 data, etc. to determine the pattern. If the initial geometric boundary were set at 25 miles (based on the factors and balancing algorithm described hereinabove), after recognizing the subscriber vehicle driving pattern, the geometric boundary may be updated to, for example, 10 miles having a circular shape with the garage address as the center. In another non-limiting example, the telematics unit 14 may recognize that for each Monday through Friday for one month a user drives 80 miles one way in the mornings and 80 miles back to his/her garage address in the evenings. Again, upon recognizing the pattern (via ignition cycles, driving distance logs, numerous registrations being sent if the initial geometric boundary is less than 80 miles), the telematics unit 14 would update the initial geometric boundary to, for example, 80 miles having a shape that encompasses the driving route (where the garage address is not necessarily the geometric center).

When the call center 24 performs the monitoring, service events may include registrations received by the call center 24, preparation or transmission of vehicle diagnostic reports, turn-by-turn navigation system usage, and other like call center-provided services that may assist in identifying driving patterns. The call center 24 may log communications between the vehicle 12 and the call center 24 in order to monitor such events. Furthermore, when in communication with the vehicle 12, the call center 24 may request ignition cycle, GPS component 44, driving distance and/or driving speed logs from the telematics unit 14 for analysis. Monitoring performed by the call center 24 may also be accomplished for any amount of time that is sufficient to recognize a pattern. As previously mentioned, if/when the call center 24 recognizes the pattern, it (e.g., via computer equipment 74 containing software that is configured to monitor such data, and use preset thresholds to alter the shape of the boundary) may update the geometric boundary stored in its user profile based on the pattern. The updated geometric boundary is also sent to the telematics unit 14 so that the telematics unit 14 and call center 24 have identical information for the subscriber vehicle 12.

It is to be understood that when determining whether to update the initially set geometric boundary, the balancing algorithm may be run again, taking into account the proposed dimensions (and the estimated number of registrations/messages likely to be sent with the proposed dimensions) of the updated geometric boundary, and the geographic and/or account factors previously described.

Furthermore, the monitoring and updating may be accomplished any time after the initial geometric boundary is set or after it has been updated one or more times. For example, if the initial boundary is updated for the user's driving pattern and then the user changes jobs and develops a different driving pattern, the telematics unit 14 or call center 24 may recognize the changes in the pattern and update the geometric boundary based on the newest pattern.

It is believed that the updated geometric boundary enables the call center 24 to target messages for each subscriber vehicle 12. Such messages are based upon the updated geometric boundary, and are transmitted to the subscriber vehicle 12 when appropriate or desirable, as shown at reference numeral 208. Such messages may relate to traffic reports/incidents, weather events, crisis situations, or other like events that are affecting or are likely to affect the area included in updated geometric boundary. It is believed that the messages will be more targeted than messages sent using an average boundary because the individualized boundary enables the call center 24 to project where a subscriber vehicle is likely to be in the short-term future. It is to be understood that the messages may be transmitted to the vehicle 12 such that they are emitted audibly through speaker 30 or such that they are displayed on a screen of the display 80.

Referring now to FIG. 3, a map illustrating the initial geometric boundary (labeled IGB) and the updated geometric boundary (labeled UGB) for the subscriber vehicle 12 is depicted. In this instance, the location marked “A” is the subscriber vehicle's garage address, and the destination marked “B” is the address to which the vehicle 12 travels five days a week. The initial geometric boundary IGB is based on the garage address, the geographic and account factors for the user, and the balancing algorithm described hereinabove. After recognizing the driving pattern of the vehicle 12 to and from locations A and B, the telematics unit 14 or call center 24 updates the vehicle's geometric boundary UGB to be a rectangular shape that includes points A and B. This updated geometric boundary UGB reduces the number of registration transmission to the call center 24 and enabled more targeted messages to be delivered to the vehicle 12.

FIG. 3 also illustrates an example of a targeted message that is transmitted to the vehicle 12. Since the vehicle 12 travels on I-75 twice a day every weekday, the call center 24 may recognize that an accident on I-75 in the morning on a particular day is likely to affect the driver's commute. As such, the call center 24 may transmit a message (similar to that shown in FIG. 3) to the subscriber vehicle 12 indicating the details of the traffic incident. It is to be understood that another subscriber vehicle (not shown) having a geometric boundary corresponding to the initial geographic boundary IGB shown in FIG. 3 would not be alerted of the accident at I-75 and M-59 because the incident is not within the geometric boundary of the other vehicle.

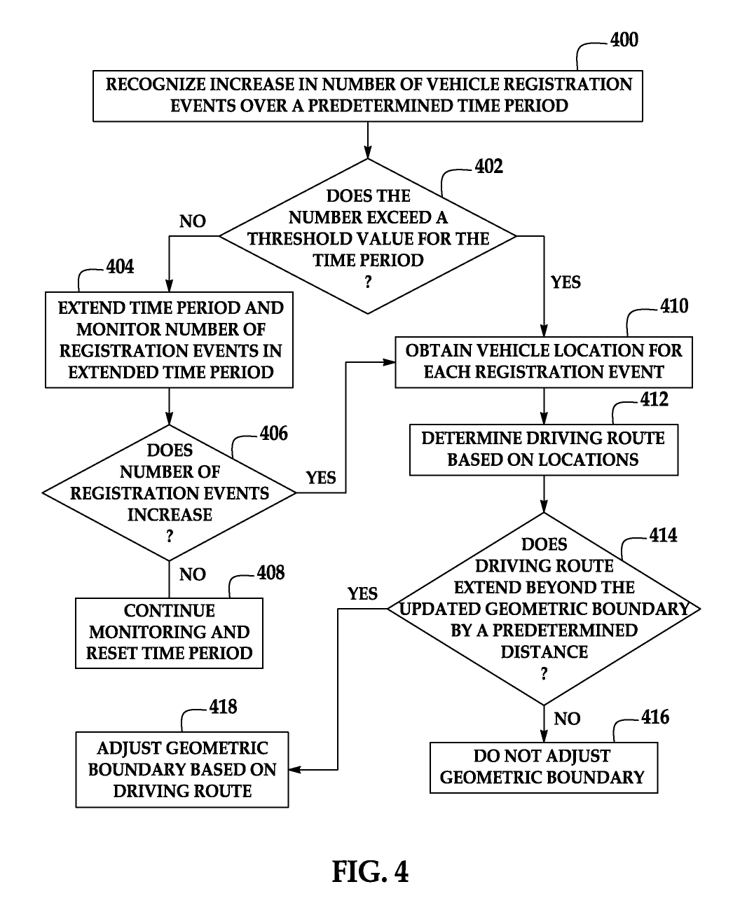

FIG. 4 depicts another example of the method after the geometric boundary has been updated one or more times. This method is utilized to determine whether the geometric boundary of the subscriber vehicle 12 should be updated permanently or temporarily (e.g., if the user is on a trip).

As shown at reference numeral 400, the telematics unit 14 or call center 24 recognizes that an increased number of vehicle registrations (registration events) have been transmitted to the call center 24 over a predetermined time period. The predetermined time period may be set at any desirable time, and may vary from one subscriber vehicle to another subscriber vehicle. Generally, the predetermined time is based upon, at least in part, previously recognized driving patterns of the subscriber vehicle 12. As one example, if it is recognized that a subscriber vehicle 12 routinely travels outside his/her updated geometric boundary once a week, the predetermined time may be set for a longer time period, e.g., at 72 hours. It is believed that recognizing that the registrations are increasing over this time period may assist the telematics unit 14 or call center 24 in determining whether to adjust or update the geometric boundary permanently, temporarily or at all.

Since an increase in transmitted registrations means that the vehicle 12 is outside the boundary, the telematics unit 14 or call center 24 compares the number of registrations with a threshold value for the time period, as shown at reference numeral 402. This threshold value may also be based upon, at least in part, previously recognized driving patterns of the subscriber vehicle 12, and thus may be particular to a vehicle 12. Using the example of the user traveling outside his/her updated geometric boundary once a week, the threshold value may be set for 5 or more registrations within the 72 hour period.

If the number of registrations does not exceed the threshold value, the telematics unit 14 or call center 24 may extend the time period and continue to monitor the number of registrations transmitted, as shown at reference numeral 404. If, after additional monitoring, the number of registrations does not exceed the threshold value, it is likely the vehicle 12 is not on a trip and does not need the boundary adjusted. In this instance, monitoring will still occur continuously in the background, but the original predetermined time period will be reset if the registration event threshold value is not exceeded during the extended time period (see reference numerals 406 and 408).

If however, the number of registrations does exceed the threshold value in the predetermined time period (see reference numeral 402) or in the extended time period (see reference numeral 406), the telematics unit 14 or call center 24 obtains the vehicle's location for each of the registration events during the predetermined or extended time period (as shown in reference numeral 410). The vehicle 12 locations may be retrieved from the GPS component 44 (or from the memory 38 which logs such data) and will assist the telematics unit 14 or the call center 24 in determining a then-current driving route of the vehicle 12, as shown at reference numeral 412.

After determining the then-current driving route from the locations, the call center 24 or telematics unit 14 can calculate whether the then-current driving route extends beyond the geometric boundary by a predetermined distance (reference numeral 414). For example, the then-current driving route will indicate whether the vehicle 12 is traveling close to, but outside, the set boundary, or whether the vehicle is continuously traveling further outside the set boundary. Such a determination will assist the telematics unit 14 or the call center in deciding whether to update the boundary based on the then-current route. Generally, if the then-current driving route is determined to be a trip, the boundary will be updated.

In one example, if the vehicle 12 is traveling close to, but outside the boundary, but does not exceed a predetermined distance (e.g., 30 miles), the boundary may not be updated, as shown at reference numeral 416. In this instance, since the vehicle 12 is relatively close to its boundary and garage address, the telematics unit 14 or call center 24 may be slower to update the boundary because such travel may be temporary. In these instances, monitoring of the driving patterns may be continued in order to determine if an update is in order.

In this example, if the vehicle 12 returns to the boundary, and does not continuously travel on the same driving route noticed during the predetermined time, the telematics unit 14 or call center 24 will not update the boundary to reflect this particular driving route. In this same example, however, if the vehicle 12 relatively routinely performs the driving route after the predetermined time has expired, the telematics unit 14 or call center 24 may recognize this as a change in the driving pattern and may update the boundary to reflect this driving pattern.

In another example, if the number of registrations continues to increase as the vehicle 12 continues to travel, the call center 24 or telematics unit 14 may conclude that the vehicle 12 is on a trip. In such instances, the boundary may be temporarily updated to reflect the driving route, as shown at reference numeral 418. This temporary adjustment will reduce the number of registration events and will allow the messages to be temporarily revised such that they are targeted for the location of the vehicle 12. In this instance, since the vehicle 12 continues to move further from the boundary and garage address, the telematics unit 14 or call center 24 may be quicker to update the boundary because, as the vehicle 12 continues to move, additional registrations will be transmitted from the vehicle 12. In these instances, monitoring of the driving patterns may be continued in order to determine if/when the previous boundary should be restored.

For example, a decrease in the number of driving registration events may signal that the trip is nearing an end or is over. When such a decrease is recognized, the telematics unit 14 or call center 24 will determine a then-current location of the vehicle 12. In one example, if the then-current vehicle location indicates that the vehicle 12 is moving toward the previously updated boundary (i.e., the boundary based on the regular routine and including the garage address), the boundary may again be temporarily adjusted until the vehicle 12 returns home and the driving pattern that is the basis of the previously updated boundary is restored. When such a pattern is restored, the previously updated geometric boundary may be reset in the vehicle 12. In another example, if the then-current vehicle location is within the previously updated (not temporarily adjusted) boundary (i.e., the boundary based on the regular routine and including the garage address), the temporary boundary may be deleted and the boundary may be reset to the previously updated boundary.

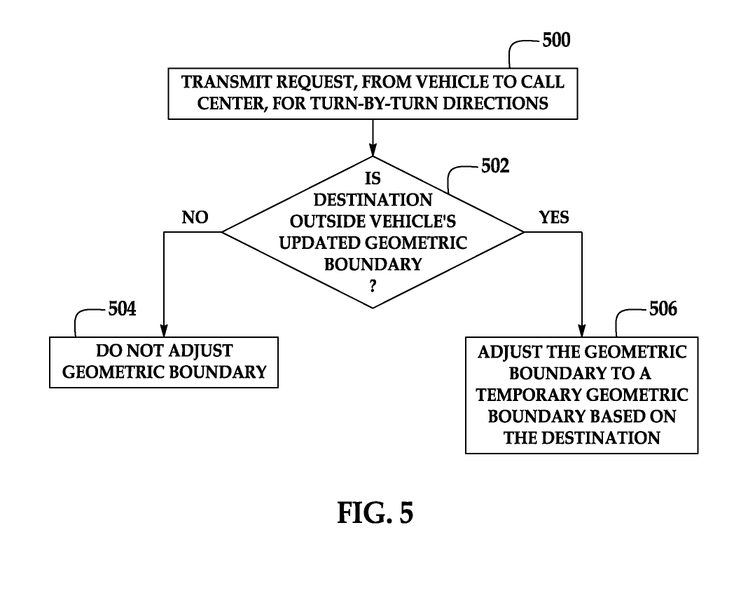

FIG. 5 depicts still another example of the method after the geometric boundary has been updated one or more times. This method is utilized when a vehicle user indicates that he/she will be traveling outside the updated boundary. In this example, the vehicle user transmits a request for turn-by-turn navigation instructions from the call center 24, as shown at reference numeral 500. Such a request may be initiated via verbal communication, physical communication, and/or combinations thereof. Physically initiating the request may be accomplished via a button press (using buttons, knobs, switches, keyboards, and/or controls 32), a touch screen, or the like located in the vehicle 12 and operatively connected to the telematics unit 14. Verbally initiating the request may take place via, e.g., the microphone 28 associated with the telematics unit 14. When the user initiates a request, the call center 24 may determine the location the vehicle 12 by allowing the user to inform the call center 24 of his/her position, and/or via the location detection system 44. In response to the request, the call center 24 generates the navigation instructions.

During or after generating the instructions, the call center 24 determines whether the destination of the requested instructions is outside of the updated geometric boundary, as shown at reference numeral 202. If the call center 24 recognizes that the destination is not outside the vehicle's boundary, the boundary is not adjusted, as shown at reference numeral 504. However, if the call center 24 recognizes that the destination is outside the vehicle's boundary, the boundary is temporarily adjusted to include the route to the requested destination, as shown at reference numeral 506.

In this example, the call center 24 may ask the user how long he/she will be within the adjusted boundary, and may set the boundary to default back to the previously updated boundary when the time indicated by the user expires. Alternatively, the telematics unit 14 or call center 24 may continue to monitor the vehicle 12 and reset the boundary when the vehicle 12 returns to the garage address.

While several examples have been described in detail, it will be apparent to those skilled in the art that the disclosed examples may be modified. Therefore, the foregoing description is to be considered exemplary rather than limiting.

1. A method for individually updating a location-based geometric boundary of a subscriber vehicle that is one of many subscriber vehicles, the method comprising:
obtaining a garage address of the subscriber vehicle;
determining a location-based geometric boundary of the subscriber vehicle from at least the garage address;
monitoring at least one of a service event including at least a vehicle registration event, a driving distance, or a driving speed to determine a driving pattern of the subscriber vehicle; and
dynamically updating the location-based geometric boundary of the subscriber vehicle based at least on the driving pattern of the subscriber vehicle.

2. The method as defined in claim 1 wherein determining, monitoring and dynamically updating are accomplished at a telematics unit of the subscriber vehicle or at a call center in selective communication with the telematics unit of the subscriber vehicle.

3. The method as defined in claim 2 wherein determining, monitoring and dynamically updating are accomplished at the telematics unit, and wherein the method further comprises transmitting at least one of the location-based geometric boundary or the updated location-based geometric boundary to the call center.

4. The method as defined in claim 2 wherein determining, monitoring and dynamically updating are accomplished at the call center, and wherein the method further comprises transmitting at least one of the location-based geometric boundary or the updated location-based geometric boundary to the telematics unit.

5. The method as defined in claim 1 wherein determining the location-based geometric boundary includes balancing an estimated number of location-based geometric boundary transmissions to a call center from the subscriber vehicle with an estimated number of target messages to be transmitted from the call center to the subscriber vehicle based on the dimensions of the location-based geometric boundary.

6. The method as defined in claim 1, further comprising tailoring targeted messages for the subscriber vehicle based on the updated location-based geometric boundary of the subscriber vehicle.

7. The method as defined in claim 1, further comprising:
recognizing an increase in a number of the vehicle registration events over a predetermined time period;
obtaining a location of the subscriber vehicle corresponding with each of the vehicle registration events;
determining a driving route based on the obtained subscriber locations;
determining whether the driving route extends beyond the updated location-based geometric boundary by a predetermined distance; and
adjusting the previously updated location-based geometric boundary based on the driving route if the driving route extends beyond the previously updated location-based geometric boundary by the predetermined distance.

8. The method as defined in claim 7 wherein if the increase in the number of vehicle registration events is above a threshold value for the predetermined time period, the method further comprises setting the adjusted location-based geometric boundary based on the driving route as a temporary location-based geometric boundary.

9. The method as defined in claim 8, further comprising:
recognizing a decrease in the number of the vehicle registration events;
in response to such recognizing, determining a then-current location of the subscriber vehicle;
determining whether the then-current location is within the previously updated location-based geometric boundary; and
resetting the temporary location-based geometric boundary to the previously updated location-based geometric boundary if the then-current location is within the previously updated location-based geometric boundary.

10. The method as defined in claim 7 wherein if the increase in the number of vehicle registration events is below a threshold value for the predetermined time period, prior to obtaining the location of the subscriber vehicle corresponding with each of the vehicle registration events, the method further comprises:
extending the predetermined time period;
monitoring the number of the vehicle registration events throughout the extended predetermined time period; and
if the number of vehicle registration events continues to increase during monitoring, then continuing with obtaining the location of the subscriber vehicle corresponding with each of the vehicle registration events.

11. The method as defined in claim 7 wherein determining the driving route is accomplished 1) at a call center, or 2) by the telematics unit.

12. The method as defined in claim 1, further comprising:
transmitting a request for turn-by-turn navigation instructions from the subscriber vehicle to a call center;
recognizing, at the call center, that a destination of the turn-by-turn navigation instructions is outside of the previously updated location-based geometric boundary; and
adjusting the previously updated location-based geometric boundary to a temporary location-based geometric boundary based on the requested turn-by-turn navigation instructions.

13. The method as defined in claim 1 wherein determining the location-based geometric boundary of the subscriber vehicle is further based on at least one of a geographic region in which the garage address is located, historical weather patterns of the geographic region, types of weather incidents in the geographic region, an account type associated with the subscriber vehicle, a population density of the geographic region, or combinations thereof.

14. The method as defined in claim 1 wherein the location-based geometric boundary and the updated location-based geometric boundary are each a geometric shape having the subscriber vehicle garage address of the subscriber vehicle as its geometric center.

15. A system for individually updating a location-based geometric boundary of a subscriber vehicle that is one of many subscriber vehicles, the system comprising:
a telematics unit operatively disposed in the subscriber vehicle;
a processor operatively connected to the telematics unit; and
a call center in selective communication with the telematics unit;
the processor configured with an algorithm for, or the call center configured for:
obtaining a garage address of the subscriber vehicle;
determining a location-based geometric boundary of the subscriber vehicle from at least the garage address;
monitoring at least one of a service event including at least a vehicle registration event, a driving distance, or a driving speed to determine a driving pattern of the subscriber vehicle; and
dynamically updating the location-based geometric boundary of the subscriber vehicle based at least on the driving pattern of the subscriber vehicle.

16. The system as defined in claim 15 wherein the processor is further configured with an algorithm for, or the call center is further configured for determining the location-based geometric boundary by balancing an estimated number of location-based geometric boundary transmissions to a call center from the subscriber vehicle with an estimated number of target messages to be transmitted from the call center to the subscriber vehicle based on the dimensions of the location-based geometric boundary.

17. The system as defined in claim 15 wherein the call center is further configured to tailor targeted messages for the subscriber vehicle based on the updated location-based geometric boundary of the subscriber vehicle.

18. The system as defined in claim 15 wherein the location-based geometric boundary and the updated location-based geometric boundary are each a geometric shape having the subscriber vehicle garage address of the subscriber vehicle as its geometric center.
